(19) United States
(12) Patent Application Publication
(10) Pub. No.: US 2008/0197114 A1
(43) Pub. Date: Aug. 21, 2008

(54) Contact Arrangement for a Vacuum Switch

(75) Inventors: Nils Anger, Berlin (DE); Roman Renz, Berlin (DE); Andreas Stelzer, Berlin (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 11/917,004

(22) PCT Filed: May 31, 2006
(86) PCT No.: PCT/EP2006/062776

§ 371 Date: Dec. 10, 2007

(30) Foreign Application Priority Data
Jun. 8, 2005 (DE) 10 2005 027 268.1

(51) Int. Cl. H01H 33/664

(52) U.S. Cl. 218/128

(57) ABSTRACT

A contact configuration for a vacuum switch includes cup-shaped contacts, which are movable one after another in a longitudinal direction and provided with slots for producing a radial magnetic field. A contact carrier whose side wall is provided with a front surface faces the opposite contact and a bottom section. Each contact has at least partially erosion-resistant contact elements, which cover at least the front surface and the internal bottom surface of the bottom section of the contact carrier facing the opposite contact.

The invention relates to a contact arrangement for a vacuum switch having cup-shaped contacts, which are arranged movably with respect to one another in a longitudinal direction and are provided with slots, for producing a radial magnetic field, each contact having a contact carrier with a side wall, which has a front surface facing the opposite contact, and a bottom section, wherein each contact has at least partially erosion-resistant contact elements.

Such a contact arrangement is disclosed in DE 31 38 086 A1. The cup contact described consists of a contact carrier with a base, which is connected to a current feed, and a wall area with ring-shaped front surface. The contact carrier in this case is made of copper. A closed contact ring, which is made of a contact material with high temperature resistance and high mechanical strength such as a chromium/copper compound, is arranged on the ring-shaped front surface of the contact carrier as a contact element. The disadvantage of such an arrangement is that an arc, which burns during contact separation and which is intended to move circumferentially on a contact surface of the contact ring, tends to “derail” at high loads, in particular with long arcing times, that is to say it runs towards the bottom, for example, and therefore burns on the contact carrier. This leads to unwanted wear due to erosion of the contact carrier material and, under certain circumstances, to re-ignition of the arc and consequently to inadequate extinguishing characteristics.

The invention is based on the object of developing an arrangement of the kind mentioned in the introduction so that transgression of the arc onto the contact carrier is prevented and the extinguishing characteristics of the arrangement are improved.

According to the invention, this object is achieved in that the contact elements cover at least the front surface and an internal bottom surface of the bottom section of the associated contact carrier facing the opposite contact.

With such an arrangement, the arc is prevented from derailing during the separation of the cup-shaped contacts of the vacuum switch. In particular, it is no longer possible for the arc to burn on the contact carrier, which is made of copper, for example on the internal bottom surface. With this arrangement according to the invention, the arc can only burn on the contact element, as a result of which the arrangement has considerably improved characteristics with regard to extinguishing the arc when the contacts separate.

A chromium/copper compound is preferably used as the material for the contact element. A copper/chromium compound has high erosion resistance and high mechanical strength.

In a preferred embodiment, the contact element is a disk-shaped contact element. As a result of such a design, the whole surface of the cup-shaped contact onto which the arc could derail is covered in a simple manner.

In a further embodiment of the invention, the disk-shaped contact element can have a circumferential section and a depression section with a reduced thickness with respect to the circumferential section. With such an arrangement, the conductivity in the depression area is lower. This leads to an additional stabilization of the movement of the circumferentially rotating arc in the circumferential section of the disk-shaped contact element.

In a preferred embodiment, the thickness of the depression section compared with the thickness of the circumferential section is at least 0.5 mm less.

In a further embodiment, the cross-sectional area of the depression section is less than or equal to the cross-sectional area of a current feed. As a result of this, the characteristics of the arrangement are further improved in that a better guidance of the arc is achieved due to the magnetic field that forms.

Furthermore, advantageously, the side wall is in the form of a hollow cylinder, and the disk-shaped contact element has on its cup side, which faces away from the opposite contact, a cylindrical elevation, the outside diameter of which is less than an inside diameter of the side wall. Such an elevation is advantageous during assembly, for example, as it guarantees guidance and centering of the disk-shaped contact element on the contact carrier. The smaller internal diameter enables the elevation to fit inside the hollow-cylindrical side wall, which considerably simplifies bringing the contact element into a required position on the cup-shaped contact.

In another embodiment, the contact element can rest against the front surface, against an inner surface of the side wall and against the internal bottom surface of the bottom section. Such an embodiment likewise guarantees guidance and centering during assembly, as well as a complete covering of the areas of the contact carrier onto which the arc can derail.

The contact element can also include a ring section for covering the front surface as well as a disk section for covering the internal bottom surface. Such an arrangement according to the invention also prevents the arc from burning on the contact carrier.

An exemplary embodiment of a cup contact for a contact arrangement according to the invention is shown schematically in the drawing.

In the drawing:

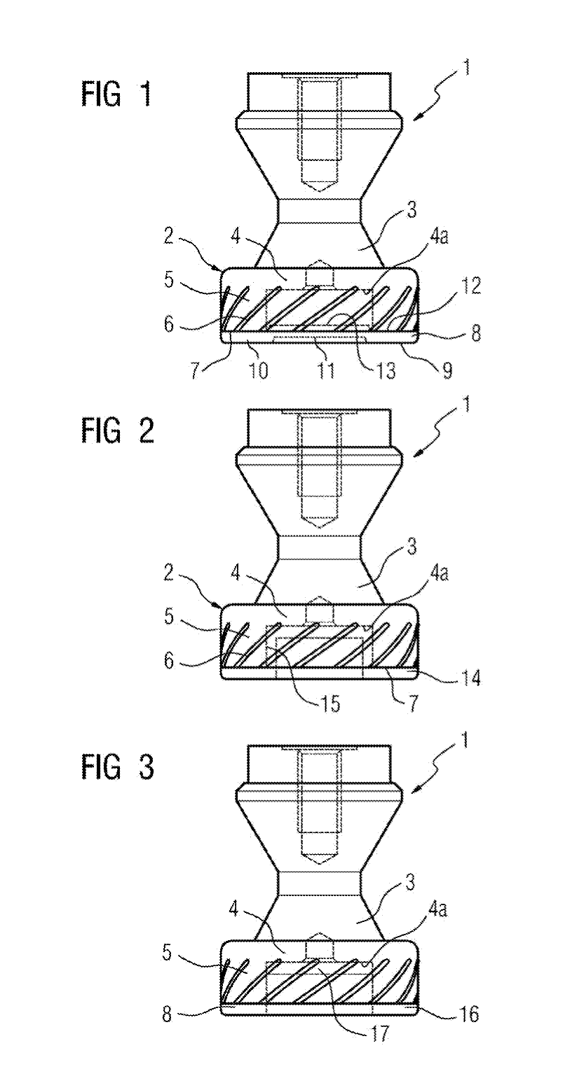

FIG. 1 shows a schematic representation of a cup contact for a vacuum switch with a disk-shaped contact element;

FIG. 2 shows a schematic representation of a cup contact for a vacuum switch with a contact element in an alternative embodiment;

FIG. 3 shows a schematic representation of a cup contact for a vacuum switch with a contact element according to the invention in a further embodiment;

FIG. 1 shows a preferred embodiment of a cup contact 1 having a contact carrier 2, which is connected to a current feed 3. The contact carrier 2 consists of a bottom section 4 with a hollow-cylindrical side wall 5 arranged thereon. As shown in the figure, the contact carrier 2 is provided with slots 6, which are angled compared with the rotational axis of the cup contact, and are able at least partially to penetrate the bottom section 4 of the contact carrier 2. The contact carrier 2 is made of copper. Arranged on a front surface 7 of the contact carrier 2 is a disk-shaped contact element 8, which is made from a material with high temperature resistance as well as high mechanical resistance and therefore a high erosion resistance, for example a chromium/copper compound. The disk-shaped contact element 8 has a circumferential section 10 as well as a depression section 11 with circular cross section, which is depressed by about 0.5 mm compared with the circumferential section 10. A cylindrical elevation 13 with an outside diameter, which is slightly smaller than the inside diameter of the hollow-cylindrical side wall 5, is formed on a cup side 12 facing the bottom section 4. This enables the cylindrical elevation 13 of the disk-shaped contact element 8 to fit in the side wall 5 of the contact carrier 2, and the disk-shaped contact element 8 is centered on the cup-shaped contact in a simple manner during assembly.

The cup contact 1 with an alternative embodiment of the contact element 14, which covers the front surface 7 as well as an inner surface 15 of the side wall 5 and an internal bottom surface 4a of the contact carrier 2, is shown in FIG. 2.

FIG. 3 shows a further embodiment of the contact element in a two-part embodiment in which a ring section 16 covers the front surface 7 of the contact carrier 2 and a disk section 17 covers the internal bottom surface 4a of the contact carrier 2.

In a contact arrangement according to the invention for a vacuum switch, two cup contacts 1 of this kind are arranged opposite one another and movably with respect to one another in a longitudinal direction. The contact carriers 2 are divided by means of the angled slots 6 into individual segments, which form a current loop with the resulting arc after the two cup contacts 1 of the vacuum switch separate. The radial magnetic field thereby produced causes the arc to rotate between the contact elements arranged on the contact carriers. The contact element in the different embodiments prevents the arc from transgressing onto the copper material of the contact carrier 2, even in the case of long arc times, where it causes unwanted material wear due to erosion.

### LIST OF REFERENCES

1 Cup contact
2 Contact carrier
3 Current feed
4 Bottom section
4a Internal bottom surface
5 Side wall
6 Slots
7 Front surface
8 Disk-shaped contact element
9 Contact side
10 Circumferential section
11 Depression section
12 Cup side
13 Elevation
14 Contact element
15 Inner surface
16 Ring section
17 Disk section

1-9. (canceled)

10. A contact configuration for a vacuum switch, comprising:
cup-shaped contacts movably disposed, with respect to one another, in a longitudinal direction and having slots formed therein for producing a radial magnetic field;
each of said cup-shaped contacts having a contact carrier with a side wall having a front surface facing a respectively opposite contact, and a bottom section formed with an internal bottom surface; and
one or more at least partially erosion-resistant contact elements covering said front surface and said internal bottom surface of the associated said contact carrier facing the respectively opposite contact.

11. The contact configuration according to claim 10, wherein said contact elements are formed of a chromium/copper compound.

12. The contact configuration according to claim 10, wherein said contact element covering said front surface is a disk-shaped contact element.

13. The contact configuration according to claim 12, wherein said disk-shaped contact element has a circumferential section and a depression section with a reduced thickness with respect to the circumferential section.

14. The contact configuration according to claim 13, wherein said depression section has a thickness less than a thickness of said circumferential section by at least 0.5 mm.

15. The contact configuration according to claim 13, wherein a cross-sectional area of said depression section is less than or equal to a cross-sectional area of a current feed.

16. The contact configuration according to claim 12, wherein said side wall is shaped as a hollow cylinder, and said disk-shaped contact element has a cup side, facing away from the respectively opposite contact, formed with a cylindrical elevation having an outer diameter less than an inner diameter of said side wall.

17. The contact configuration according to claim 10, wherein said contact element rests against said front surface, against an inner surface of said side wall, and against said internal bottom surface of said bottom section.

18. The contact configuration according to claim 10, wherein said contact elements include a ring section covering said front surface and a disk section covering said internal bottom surface.
